(19) United States
(12) Patent Application Publication
(10) Pub. No.: US 2019/0237957 A1
(43) Pub. Date: Aug. 1, 2019

(54) POWER CORD SYSTEM AND METHOD

(71) Applicant: Maritime Technology Inc., Cold Spring Harbor, NY (US)

(72) Inventors: Denis Kiely, Cold Spring Harbor, NY (US); Jason Jasovsky, Manalapan, NJ (US)

(21) Appl. No.: 16/262,828

(22) Filed: Jan. 30, 2019

Related U.S. Application Data
(60) Provisional application No. 62/624,655, filed on Jan. 31, 2018.

(51) Int. Cl. H02G 11/02; B65H 75/44; B65D 25/02

(52) U.S. Cl. CPC H02G 11/02; B65H 75/4486; B65H 2701/34; B65D 25/02; B65H 75/4402

(57) ABSTRACT

Embodiments of the invention include a cord system with a rotatable cylinder, a guide moveably coupled to a guide shaft, a roller motor configured to rotate the rotatable cylinder, and a guide motor configured to rotate the guide shaft. Some embodiments include at least one processor, a non-transitory computer-readable storage medium for tangibly storing thereon program logic for execution by the processor, where the program logic includes logic executed by the processor controlling the roller motor to feed power cord to and from the rotatable cylinder.

### RELATED APPLICATIONS

This application claims the benefit of and priority to U.S. Provisional Application No. 62/624,655, filed on Jan. 31, 2018, the entire contents of which are incorporated herein by reference.

### FIELD OF THE INVENTION

The invention generally relates to mechanisms for improving safety and productivity associated with the transport of refrigerated and/or powered containers between vessels, port and storage facilities, and land transport, and more specifically to apparatus for retraction and unwinding of electrical power cords or other elongated devices on shipping containers.

### BACKGROUND

A refrigerated container or “reefer” is a type of shipping container for freight transport of temperature sensitive cargo such as perishable goods, including foodstuffs, flowers, plants, pharmaceuticals, blood, chemical products and the like. Reefers allow such products to be transported and consumed around the world at any time of the year. There are three basic modes of transporting such goods: sea transport (conventional and/or container ships), land transport (road/rail) and air transport. Intermodal transport combines more than one of these types of transport.

In the mid to late 1800's, reefer ship cargo space was cooled by ice which was loaded at departure. This method was limited, however, by numerous factors including insulation, loading techniques, ice block size, distance and climate. Several decades ago, reefer containers were developed that use integral refrigeration units.

Generally, refrigerated containers can control temperature in ranges between plus and minus 25 degrees Celsius, with frozen goods maintained at a temperature of minus 18 degrees Celsius or lower, and chilled goods at a temperature above the freezing point. Transport refrigeration systems may also be capable of heating if necessary to maintain the correct transport temperature for chilled goods in cold climates.

The maintenance of specific temperature ranges is important because frozen foods must not be exposed to large temperature variations, which can lead to moisture migration and loss of quality. Chilled foods require close temperature control between two limits because a temperature that is too low or high can damage the foods, and a temperature that is too high can ultimately reduce shelf life.

Temperature control systems for chilled foods require refrigeration often combined with high rates of air circulation. Such demands also require a corresponding elevated level of power for intermodal containers of around 2 kW for frozen foods, and 5 kW for chilled foods. To accomplish this, reefers rely on external power from electrical power sources at a land based site (warehouse, etc.), on a cargo ship (or reefer ship), on a trailer truck, and/or on a quay (e.g., at port or loading docks, etc.) For road transport units, these power sources include, for instance, a vehicle engine or an independent engine. Rail units may operate on electricity supplied from a generator wagon. Marine refrigeration is electrically driven from the ship's supplies. In all instances, the reefer is connected to the power source by way of electrical power cords.

Some vessels transport only reefer containers. However, on other ships, reefer containers may only comprise a portion of the containers that are loaded onto a vessel. While the number of reefer containers onboard each vessel may differ significantly, each individual reefer container must be treated much differently than a regular (dry container) that does not contain cargo requiring temperature control.

To avoid spoliation, a reefer container must be connected to an electrical power source when it is loaded onto a transport vessel and/or when unloaded at a land-based site. Thus, every time a reefer container is transferred to/from ship, dockyard, truck/train, and/or warehouse, it needs to be unplugged from an electric power source at its starting location, and then plugged back in when it has been moved to its next location. It is important to minimize the amount of time that a reefer container is disconnected from an electrical power source.

There are several complicating factors in the transport of reefer containers, and their connection/disconnection to electric power sources. Reefer containers are often stacked on top of each other, both during transport and while stationary. For example, FIG. 1 shows reefer containers stacked four high. However, in some instances, reefers can be stacked up to eight containers high. A standard container is either 8′6″ or 9′6″ in height, so the access point for the respective container reefer power cord can be up to 76′ high.

Because electrical outlets that are configured for plugging in the reefer power cords onboard a ship are typically located on the deck of the ship, the plug locations can be located where the first tier of reefers are located. For example, FIG. 2 shows a reefer container stacked five high so they can be on the deck located across the 1st tier. Accordingly, in order to be plugged in, the cords must be dropped from a compartment in the container, and hung down from all of the tiers above the first tier to the deck of the vessel. For example, FIG. 3 shows stacked reefers with cords plugged into receptacles on the deck of the ship (i.e., where the crew would stand.) Land-based transfer and storage of reefer containers use similar configurations.

For the last several decades, various approaches have been taken with respect to handling of reefer power cords when transferring containers between ships, loading docks, storage facilities, and trucks. Historically, the repeated unraveling, plugging in, unplugging and re-bundling of the cords (e.g., during discharge from vessel to dock, movement from dock to other areas of the yard, or transfer of reefer from yard to truck for delivery outside of the terminal), has been accomplished using ladders and personnel must often climb several levels above floor level. This creates obvious safety issues, especially in the often-limited space and high activity areas that they must operate within. FIG. 4 shows a picture of wires hanging from containers stacked two high on a vessel, and illustrates how they can become entangled in the container restraints.

In addition to the safety dangers to shipping personnel presented by the handling of dangling electric power cords, there are other serious risks that the cord will be shredded, severed, nicked or otherwise damaged leading to expensive repair costs, delays and/or corresponding voltage hazards. For instance, oftentimes, in an attempt to avoid the costly delays associated with manually bundling dangling reefer cords into their respective container compartments several levels above ground, containers will be removed from a ship by crane to a land-based loading area with their reefer cords dangling. This creates the risk of a container being lowered onto its own reefer cord. To address this issue, a container may need to be lifted again or to be stopped in the air a short distance above the ground so that personnel can bundle up and tuck the cord away in its compartment.

During the process of reefer transport and transfer, a mechanic/operator disconnects the plug from the socket. The disconnected cord may be hanging from various heights depending on how high the container is stacked. In general, this issue is handled in one of two ways, where either the mechanic/operator coils the cord up, and climbs on a ladder to tuck it into the housing (thereby presenting significant safety and delay issues when addressing hundreds of reefers), or, the cord can be left hanging during transfer of the container. At that point, the container can be dropped on the dock, where a longshoreman can coil the cord up and place it in the housing. Once that is done, it is placed on a truck to be taken to the yard where it will be stored. The cord is then placed back in the housing so that the truck is not driving to its yard destination with the cord dragging under and/or behind the truck. The extra process of having to drop the reefer to the dock to tuck the cord would likely take two minutes, however when working with hundreds of reefers, the additional time is significant, as is the cost, where each crane and associated workers can cost several thousand dollars per hour.

Once the reefer is discharged from the vessel, it is placed in a stack within the yard facility in preparation for it to be picked up by a truck and taken to its ultimate destination. In general, the reefer will stay on power in the yard for a period of one to three days prior to being picked up by a trucker. For example, see FIGS. 5-8 for pictures of how these containers look stacked in different yards. While each individual yard is different, the same issues apply. For example, when the reefer arrives at a yard stack following discharge from the vessel, it is stacked and the cord is placed in the housed position. The cord needs to be dropped from the housing to the ground so it can again be plugged in to a power source. This again requires a longshoreman to either climb on a ladder or go up in an elevated lift such as a “cherry picker” type of device to drop the cord from the housing to the ground to be plugged in again. This procedure carries risks of severe injury and is very time consuming. Once the trucker arrives to transport the reefer container out of the yard, the process is repeated.

In order to be placed on the truck, the cord needs to be unplugged, coiled-up, and put in the housed position again. This part of the process is compounded by the fact that if the box is not the top box (i.e., the first pick for the crane), then the other boxes on top of the one being delivered need to be unplugged and stowed in the housing unit to get the targeted reefer. This also adds to trucker congestion in yards, which is an issue that plagues container terminals worldwide.

Stored cords can develop excessive wear and damage, including breaks and fraying, as a result of the cord and/or plug being repeatedly kinked and/or rolled up in different ways. For example, FIGS. 9A-9B illustrate conventional cord storage. Further, the cords are not always put in fully stowed in the housing unit, and it is commonplace for the cords to snag and rip during the constant moving of these units. Frayed and/or damaged power cords can pose a significant risk to their handlers including electric shock, fire hazards, and are generally a violation of safety codes requiring repair before continued use. Due to the stringent temperature maintenance requirements of intermodal containers, damaged reefer cords and plugs must be repaired or replaced at the earliest possible time.

Accordingly, there is a continuing need in the art to reduce the cost of labor associated with loading and unloading of refrigerated containers into and from vessels. Any apparatus and/or method that reduces or eliminates the need to drop reefers to the dock with cords hanging from the container in order to tuck the cords away in their stowed position would increase productivity on vessels working (specifically vessels that handle refrigerated containers). An improved apparatus and/or method could allow vessels to stack refrigerated containers higher on the decks of vessels with no risk/labor cost associated with handling of reefer cords. Such an apparatus and/or method could reduce the amount of time and injury risk (and related workman's compensation cases) associated with labor working aloft in elevated lifts while stowing cords either on a vessel or in a container yard.

Additionally, there is a need for an apparatus and/or method to overcome the foregoing deficiencies to provide a safe storage environment that prevents cords from snagging, and enables the cords to coil in a uniform way to prevent kinking/breaks. This would significantly lengthen the cord life on refrigerated containers due to less exposure to the elements and reduced movement of containers with the cords hanging. In one example, transport lines would see a reduction in repairs to damaged cords. Lastly, the apparatus and/or methods should protect the cord from harsh elements (e.g., such as those found at sea, including cold weather, snow, and ice, and brine).

### SUMMARY

Some embodiments include a cord system comprising a housing configured and arranged for coupling to a container. Some embodiments include a cylinder supported for rotation, a guide moveably coupled to a guide shaft, and a roller motor coupled to rotate the rotatable cylinder. Some embodiments include a guide motor configured to rotate the guide shaft.

Some embodiments further comprise a belt or chain coupled to a drive shaft of the roller motor and a shaft of the cylinder. In some embodiments, the guide comprises a block including at least one aperture. In some embodiments, the at least one aperture comprises a threaded aperture. In some embodiments, the guide is coupled by a support rod. In some embodiments, the guide shaft is positioned through the at least one aperture, where upon a rotation of the guide shaft by the guide motor, the guide is configured to move along the guide shaft. In some further embodiments, the guide shaft is positioned through the guide, wherein upon a rotation of the guide shaft by the guide motor, the guide is configured to move along the guide shaft.

In some embodiments of the invention, the guide comprises an aperture configured to support a power cord, where upon a rotation of the guide shaft by the guide motor, the guide is configured to move along the guide shaft moving a position of a portion of the power cord along a length of the rotatable cylinder.

Some embodiments include a rotatable cylinder, a guide moveably coupled to a rotatable guide shaft, a roller motor configured to rotate the rotatable cylinder, a guide motor configured to rotate the guide shaft, and at least one processor. Some embodiments include a non-transitory computer-readable storage medium for tangibly storing thereon program logic for execution by the processor. In some embodiments, the program logic comprises logic executed by the processor for controlling at least one of the roller motor and/or the guide motor.

Some embodiments further comprise logic executed by the processor for displaying a user interface of a controller, where the user interface is configured to include a display of one or more controls for controlling rotation of at least one of the rotatable cylinder and the guide shaft. In some embodiments, the user interface comprises a remote wireless user device.

Some embodiments further comprise logic executed by the processor for storing in the non-transitory computer readable medium, a specific container number of a container coupled to the system. Some embodiments further comprise logic executed by the processor to establish a direct link to the controller of the system for the specific container number.

Some embodiments include controls that comprise at least one of “up” and “down” buttons to control rotation of at least one of the rotatable cylinder to wind-up or wind-down a power cord. Some embodiments further comprise logic executed by the processor to display at least one of a launch display and login display to enable a user to log into the system. Further some embodiments include a “touch ID” entry for security and a login security protocol including at least one of a username and password, and two factor authentication.

Some embodiments include a system comprising a rotatable cylinder, a roller motor configured to rotate the rotatable cylinder, and a moveable assembly configured to feed a power cord to or from the rotatable cylinder. Some embodiments include at least one processor, and a non-transitory computer-readable storage medium for tangibly storing thereon program logic for execution by the processor, where the program logic comprises logic executed by the processor controlling at least one of the roller motor, rotation of the cylinder, and the feed of the power cord.

Some embodiments further comprise logic executed by the processor enabling a container number to be entered from a remote user interface and establishing a direct link to a controller of the system coupled to a container associated with the container number.

Some embodiments include a cord system comprising a rotatable cylinder. Some embodiments include a roller motor configured to reversibly rotate the cylinder. Some embodiments include a moveable assembly configured to guide a power cord to or from the rotatable cylinder. Some embodiments include at least one processor; and a non-transitory computer-readable storage medium for tangibly storing thereon program logic for execution by the processor, the program logic comprising: logic executed by the processor for controlling at least the roller motor. Further some embodiments include logic executed by the processor enabling a container number to be entered from a remote user interface establishing a link to the cord system coupled to the container.

### DESCRIPTION OF THE DRAWINGS

FIG. 1 shows reefer containers stacked four high.

FIG. 2 shows reefer containers stacked five high so they can be on the deck located across the 1st tier.

FIGS. 3 and 4 show cords hanging from stacked reefers on vessels plugged into receptacles on the deck of the ship.

FIG. 5 shows a picture of wires hanging from containers stacked two high on a vessel illustrating how they can become entangled in the container restraints.

FIG. 6-8 illustrates example images of containers stacked in yards.

FIGS. 9A-9B illustrates conventional cord storage.

FIGS. 10A-10B illustrate perspective views of a reefer cord system in accordance with some embodiments of the invention.

FIGS. 11A-11B illustrate perspective views of an operation assembly of the reefer cord system of FIGS. 10A-10B in accordance with some embodiments of the invention.

FIG. 12 illustrates a top view of a reefer cord system in accordance with some embodiments of the invention.

FIG. 13 illustrates a front view of a reefer cord system in accordance with some embodiments of the invention.

FIG. 14 illustrates a left side view of a reefer cord system in accordance with some embodiments of the invention.

FIG. 15 illustrates a right-side view of a reefer cord system in accordance with some embodiments of the invention.

FIG. 16A shows an installed view of a reefer cord system in a container in accordance with some embodiments of the invention.

FIG. 16B shows a cutaway cross-section top view of the reefer cord system in a container in accordance with some embodiments of the invention.

FIG. 16C shows a cutaway cross-section side view of the reefer cord system in a container in accordance with some embodiments of the invention.

FIG. 16D shows a front view of a reefer cord system in accordance with some further embodiments of the invention.

FIG. 16E shows a perspective view of a reefer cord system in accordance with some further embodiments of the invention.

FIG. 16F shows a bearing flange in accordance with some embodiments of the invention.

FIG. 16G shows a front perspective view of a guide in accordance with some embodiments of the invention.

FIG. 16H shows a rear perspective view of a guide in accordance with some embodiments of the invention.

FIG. 161 shows a side view of a guide in accordance with some embodiments of the invention.

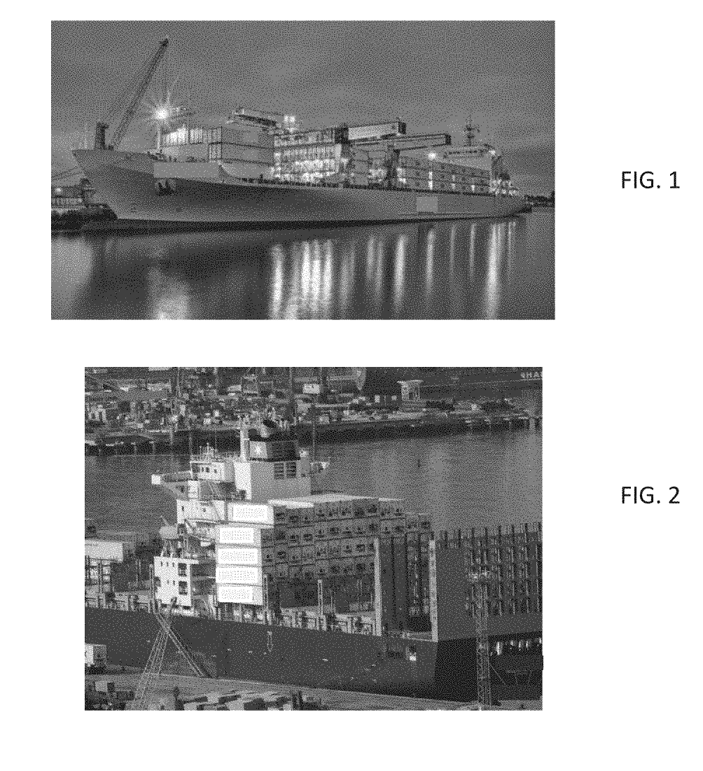

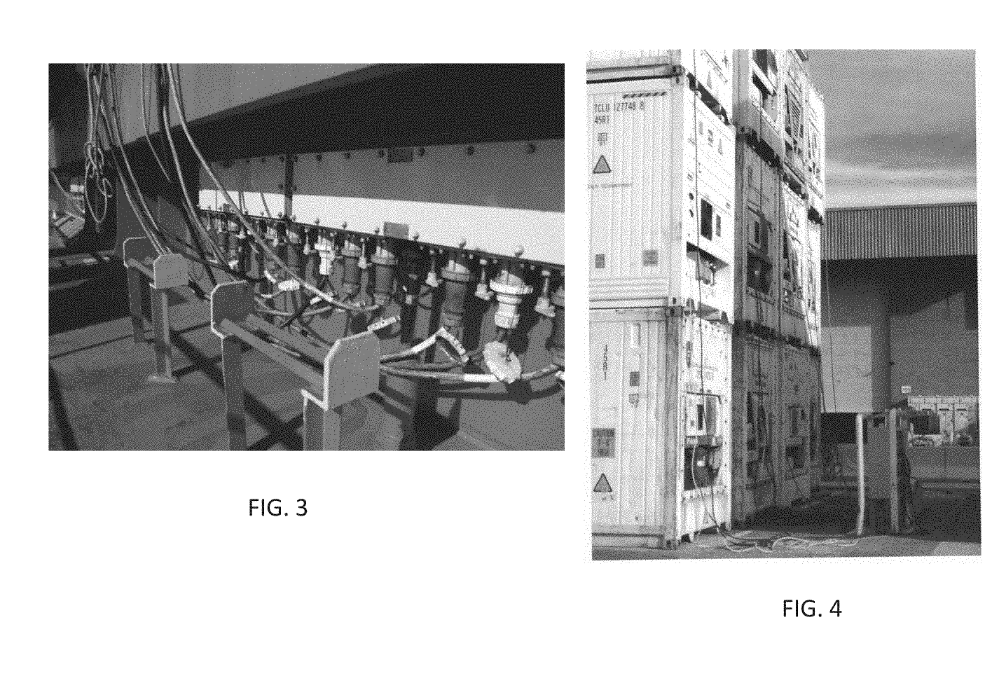

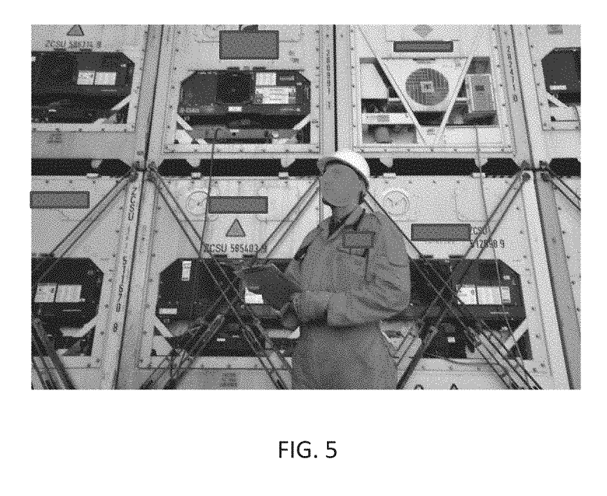

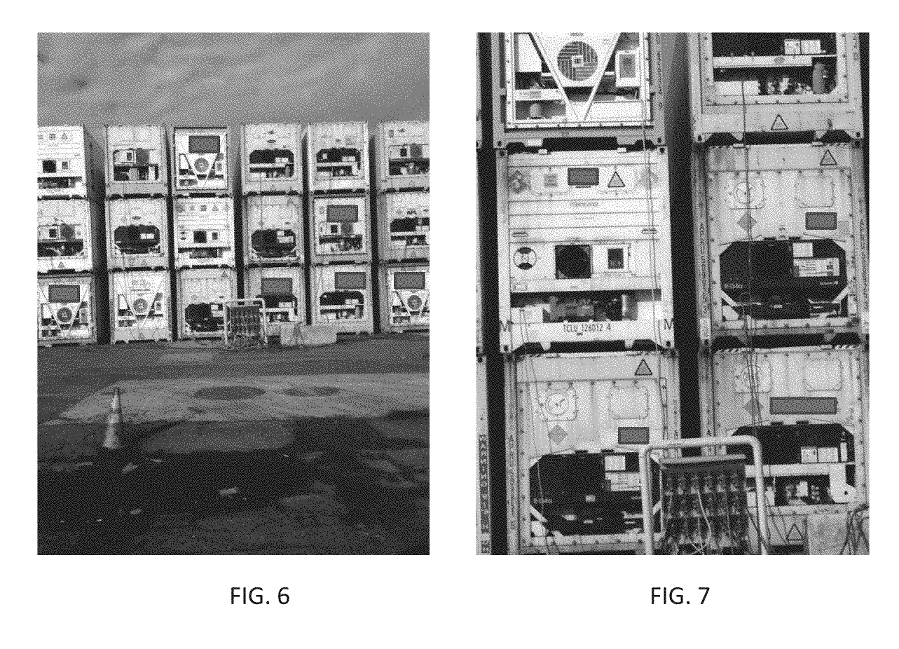

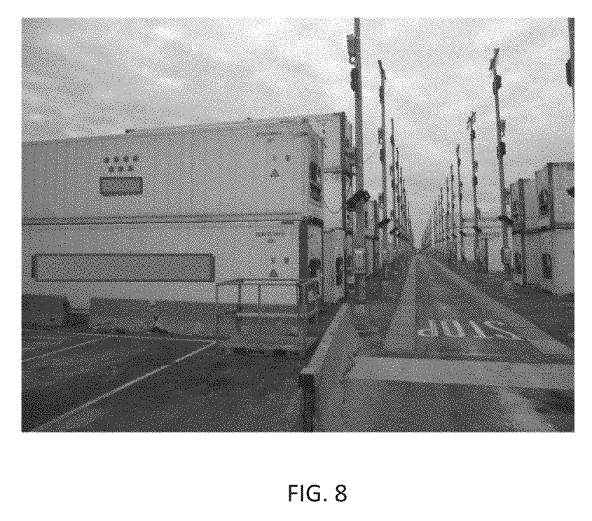

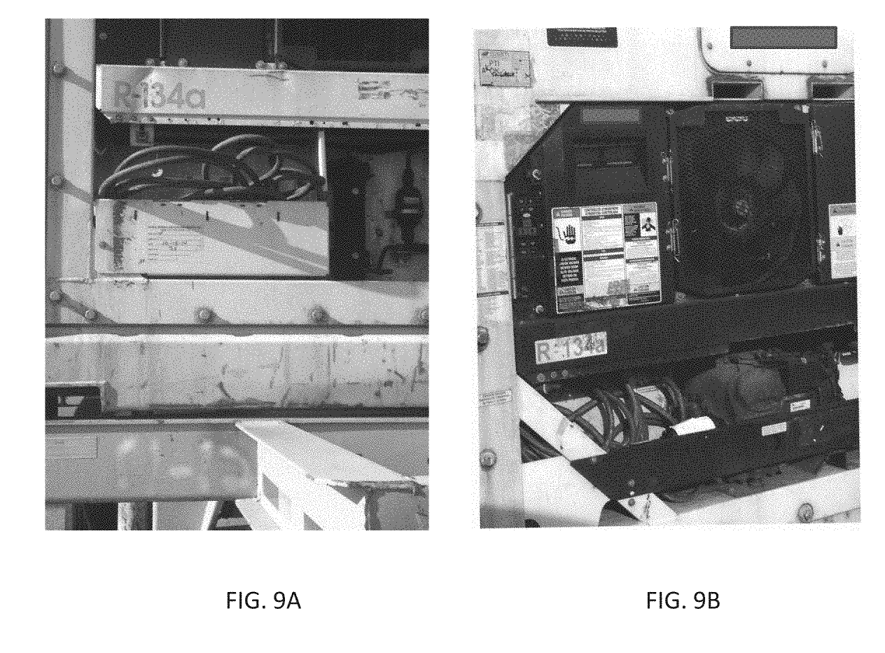

FIG. 17 illustrates a block diagram of a system implementing controller software in accordance with some embodiments of the invention.

FIGS. 18A-18C illustrate mobile displays of an API of the reefer cord system in accordance with some embodiments of the invention.

FIGS. 19A-19C illustrate mobile displays of an API of the reefer cord system in accordance with some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily-apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Some embodiments of the invention include a power cord storage and delivery apparatus. An operator or mechanic unplugging a container from a power source on a ship may retract the power cord of the cord storage and delivery apparatus, and unplug it on the vessel. During use, instead of the crane dropping the container to the dock, the container can be transported directly to a truck, as opposed to the operator dropping, stowing, then putting on a truck. Some embodiments include a reefer cord system with at least one electric motor and at least one coupled cord cylinder that can be used to retract or extend a power cord. In general terms, the reefer cord system can be a “retractable” reefer cord system in that it includes motors, gears, shafts, rods that can function to retract a power cord. However, depending the configuration and operation of one or more motors of the reefer cord system, the reefer cord system can also be used to maintain a power cord in a stationary position, or alternatively, can be used to extend a power cord. For example, some embodiments include an apparatus comprising a frame that functions as a housing and support structure for one or more motors, gears, shafts, rods of the retractable reefer cord system. In some embodiments, the apparatus can be adjusted for any size and shape, and can be sized for use with a standard container, and also can be applied to any other sizes.

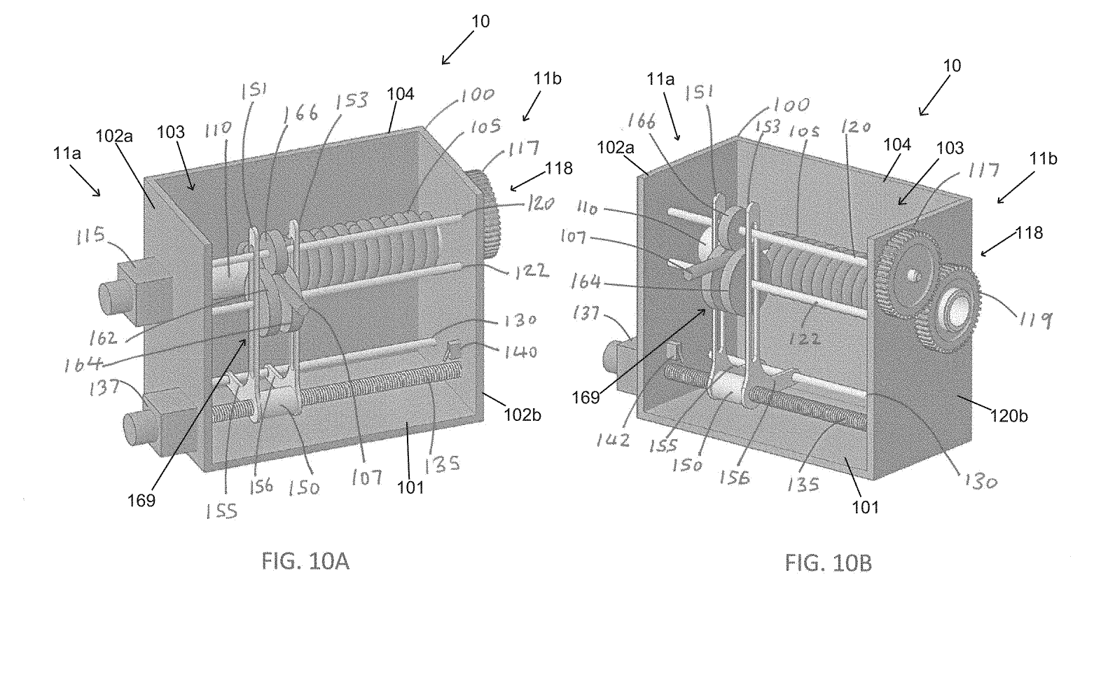

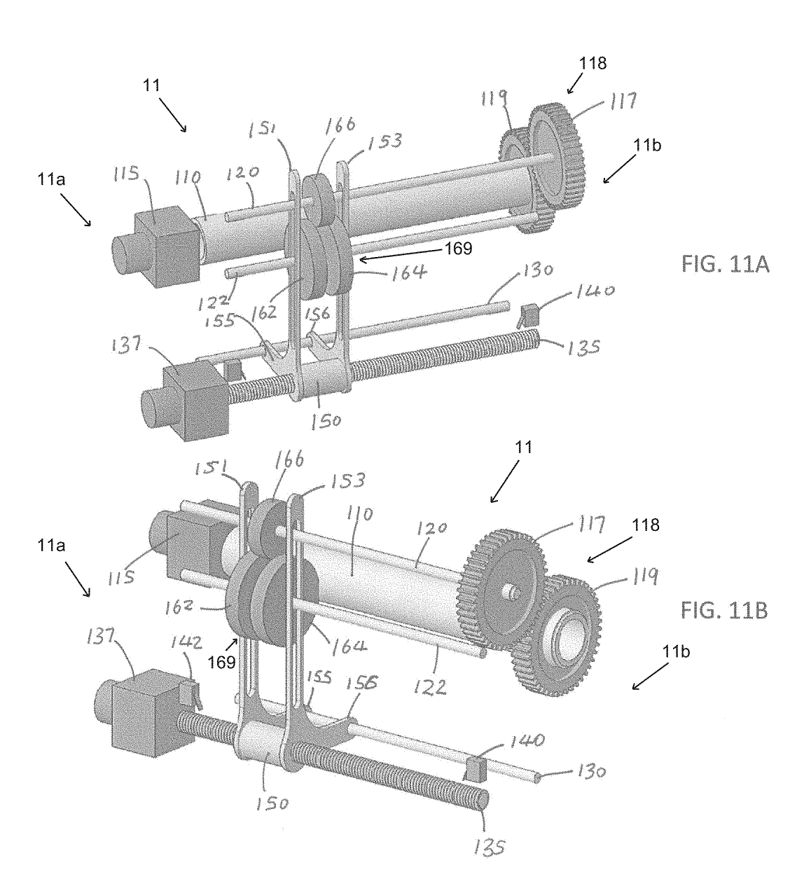

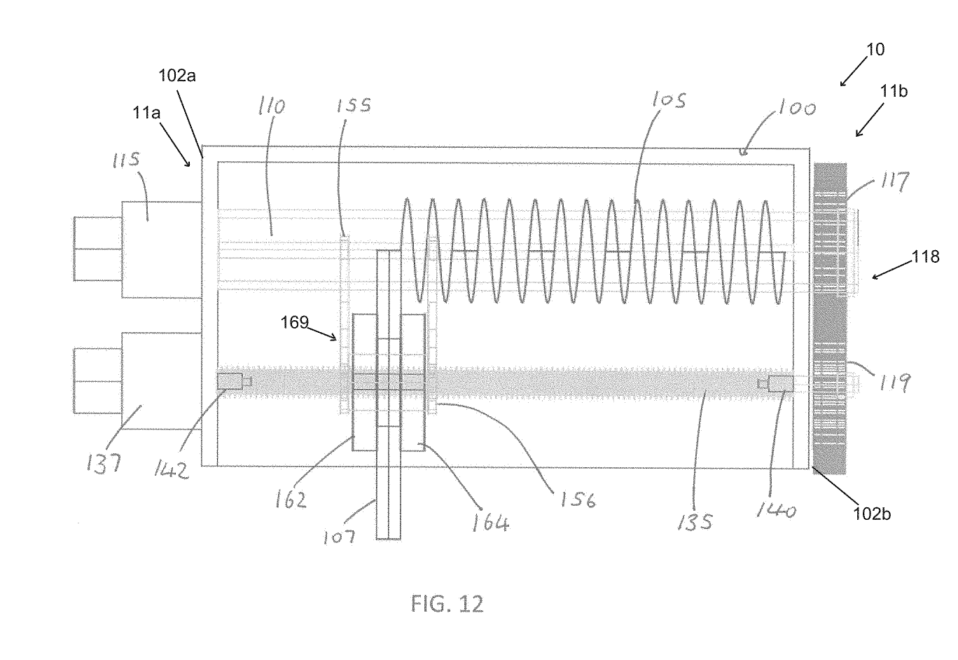

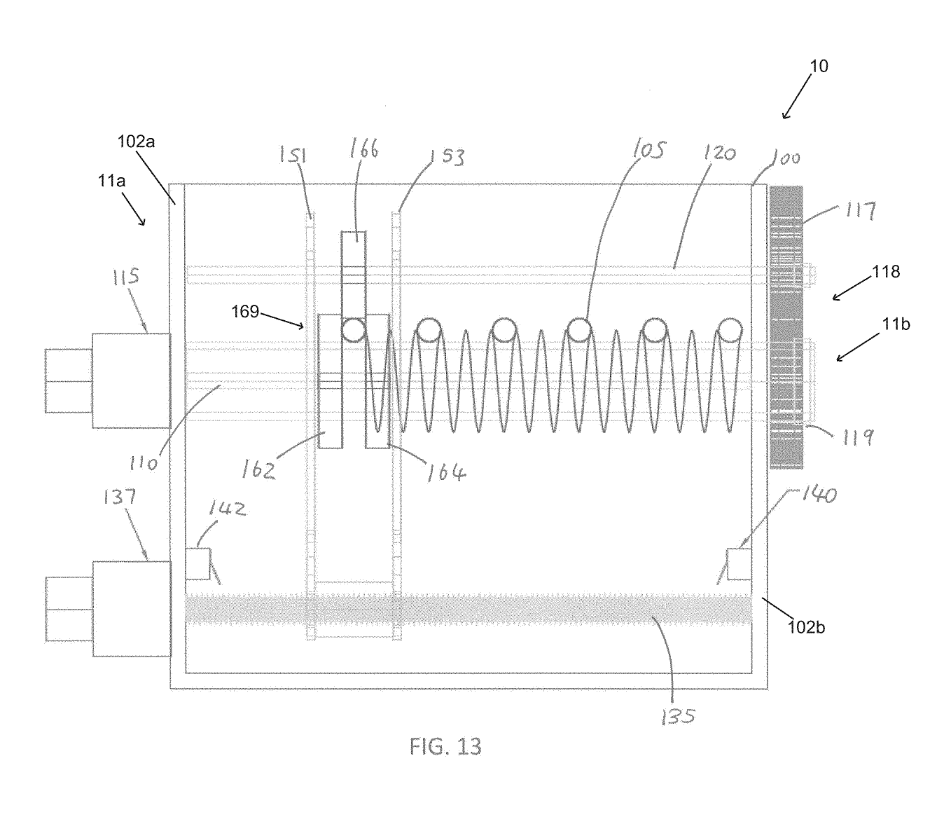

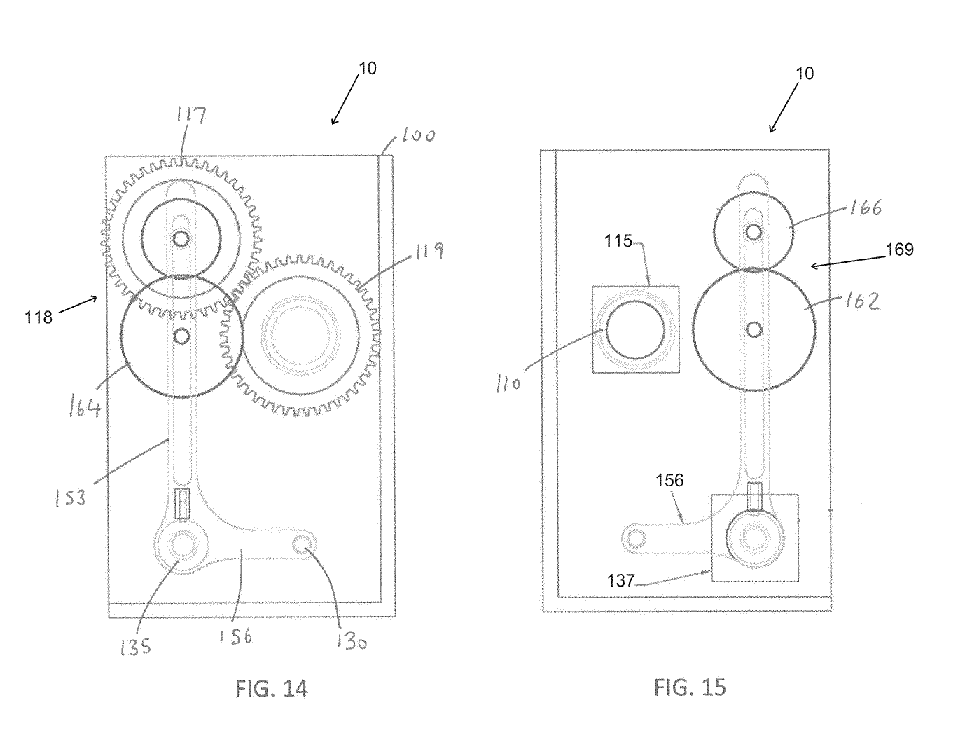

Some embodiments can include a roller motor driving a cylinder to retract or extend at least one electrical reefer cord, and at least one guide motor driving a threaded rod that drives a guide bracket. In some embodiments, the roller motor can drive the cylinder to retract or extend a reefer power cord. In some embodiments, the cylinder can be coupled by one or more cogs or gears to a tensioner rod including cogs or gears. As will be described in further detail below, in some embodiments, a guide motor can drive a threaded guide rod, and as the guide rod rotates, a threaded bracket can move along the threaded rod. For example, FIGS. 10A-10B illustrate perspective views of a cord support system 10 (also referred to herein as a cord support system or reefer cord support system) in accordance with some embodiments of the invention, and FIGS. 11A-11B illustrate perspective views of an operation assembly 11 of the reefer cord system 10 of FIGS. 10A-10B in accordance with some embodiments of the invention. Further views are shown in FIGS. 12-16. For example, FIG. 12 illustrates a top view of a reefer cord system 10, and FIG. 13 illustrates a front view of a reefer cord system 10 in accordance with some embodiments of the invention. FIG. 14 illustrates a left side view of a reefer cord system 10 (shown with motors 115, 137 and power cord 105 removed), and FIG. 15 includes a right-side view of a reefer cord system 10 (with gears 117, 119 and power cord 105 removed, and showing motors 115, 137) illustrated in accordance with some embodiments of the invention.

Referring to FIGS. 10A-10B, some embodiments include a reefer cord system 10 comprising a housing 100 that functions as a housing and support structure for one or more motors, gears, shafts, rods of the reefer cord system 10. In some embodiments, the reefer cord system 10 can be adjusted for any size and shape. In some embodiments, the reefer cord system 10 can be sized for use with a standard shipping container, but can be applied to any other container sizes. In some embodiments, the housing 100 can include a back side 104, and two end sides 102a, 102b, with end side 102a positioned at a first end 11a, and an end side 102b positioned at a second end 11b, and extending from each end of the back side 104. In some embodiments, the reefer cord system 10 can comprise a base 101 extending from the back side 104 between the first end 11a and second end 11b, and along at least a partial length of the two end sides 102a, 102b. In some embodiments, the coupled arrangement of the two end sides 102a, 102b, base 101, and back side 104 can form an internal storage compartment 103 of the housing 100. Although not shown in the figures, in some further embodiments, the housing 100 can include a lid extending from the back side 104 between the first end 11a and second end 11b, and along at least a partial length of the two end sides 102a, 102b. Further, although not shown in the figures, in some further embodiments, the housing 100 can include a front side extending between the first end 11a and second end 11b, and along at least a partial length of the two end sides 102a, 102b and at least a partial length of the base 101. However, any front side can be sized to not extend to cover or interfere with cord 107 passing into the internal storage compartment 103 of the reefer cord system 10.

In some embodiments, the reefer cord system 10 can include a roller motor 115 positioned at the first end 11a, coupled to and capable of driving a cylinder 110. In some embodiments, the cylinder 110 can be used to retract or extend an electrical reefer cord (e.g., power cord 107, shown wrapped on the cylinder 110 as power cord 105). In some embodiments of the invention, the cylinder 110 can be substantially cylindrical as shown. However, in other embodiments, the cylinder 110 can include portions that are not substantially cylindrical. In some embodiments, at least some portions of the cylinder 110 can comprise a non-cylindrical shape. Additionally, at least portions of the ends of the cylinder can be open or closed.

In some embodiments of the invention, the roller motor 115 can be coupled to end side 102a of the housing 100. In some embodiments, the roller motor 115 can include at least a portion that extends through end side 102a (e.g., such as a drive shaft that couples to and drives the cylinder 110). In some embodiments, a substantial portion of the roller motor 115 can be positioned through the end side 102a. In some other embodiments, at least a portion of the roller motor 115 can be positioned on an opposite side of the end side 102a. In some further embodiments, the roller motor 115 can be positioned on the end side 102a within the internal storage compartment 103.

In some embodiments, the reefer cord system 10 can include a guide motor 137 coupled to a threaded rod 135 positioned extending between the two end sides 102a, 102b within the internal storage compartment 103. In some embodiments of the invention, the guide motor 137 can be coupled to the end side 102a of the housing 100. In some embodiments, the guide motor 137 can include at least a portion that extends through the end side 102a (e.g., such as a drive shaft of the guide motor 137). In some embodiments, a significant portion of the guide motor 137 can be positioned through the end side 102a. In some other embodiments, at least a portion of the guide motor 137 can be positioned on an opposite side of the end side 102a. In some further embodiments, the guide motor 137 can be positioned on end side 102a within the internal storage compartment 103 (not shown). In some embodiments, the reefer cord system 10 can include a guide motor 137 can include a drive shaft coupled to the threaded rod 135. In some embodiments, the guide motor 137 can drive the threaded guide rod 135 using the drive shaft. Further, in some embodiments, as the guide rod 135 rotates, a threaded bracket 150 can move along the threaded guide rod 135. Referring to at least FIGS. 11A-11B, and FIGS. 12-15, in some embodiments, the threaded bracket 150 can comprise guide arms 155, 156 moveably coupled to guide rod 130, with guide arms 151, 153 extending substantially perpendicularly from guide arms 155, 156, wherein each of the guide arms 155, 156 can comprise an aperture through which lower rod 122 can pass. In some embodiments, the roller motor 115 and/or guide motor 137 can be positioned on the second end 11b of the reefer cord system 10.

In some embodiments, the roller motor 115 driving the cylinder 110 can retract or extend power cord 105 as the roller motor 115 rotates the cylinder 110. As shown in FIG. 10B, in some embodiments, the cylinder 110 is coupled to a gear 119 of gear assembly 118 positioned at the second end 11b, coupled to end side 102b. In some embodiments, the roller motor 115 can drive the cylinder 110 to retract or extend power cord 105, depending on whether the roller motor 115 operates in one drive direction versus an opposite drive direction. In some embodiments, the cylinder 110 can be coupled by the gear 119 to a tensioner rod 120 including a gear 117 of the gear assembly 118. In some embodiments, when the roller motor 115 and/or guide motor 137 are positioned on the second end 11b of the reefer cord system 10, the gear assembly 118 can be positioned at the first end 11a.

In some embodiments, as the guide rod 135 rotates, threaded bracket 150 can move along the threaded guide rod 135, where the bracket 150 can traverse back and forth along the threaded rod 135 to help guide power cord 105 to wind or unwind on cylinder 110. In some embodiments, limit switches 140, 142 can be installed on or adjacent either or both ends of the threaded rod 135, so that when the threaded bracket 150 traverses the rod 135 and reaches end sides 102a, 102b, limit switches 140, 142 can be actuated.

In some embodiments, a shaft of the roller motor 115 can be coupled to an axle of a cylinder 110 with a chain. In some further embodiments, the shaft of the roller motor 115 can be coupled to the axle of the cylinder 110 with a belt or other conventional drive mechanism. In some other embodiments, the roller motor 115 and cylinder 110 can be mounted vertically. In some further embodiments, the roller motor 115 and cylinder (110) are mounted horizontally. In some embodiments, the roller motor 115 can comprise a motor with an operating voltage of 24 Vdc. In other embodiments, the roller motor 115 can comprise a lower or higher operating voltage.

In some embodiments of the invention, the power cord 107 can be fed into and out of an internal storage compartment 103 and onto or off cylinder 110 (shown as wound power cord 105) by a series of spring-loaded friction rollers of a roller assembly 169. In some embodiments, the roller motor 115 can directly drive at least one of the rollers of the roller assembly 169 which can be spring compressed (or otherwise conventionally biased) against a portion 107 of the power cord 105 and another friction roller, wherein the second friction roller's position can be fixed.

In some embodiments, the threaded bracket 150 can be coupled or connected to a roller assembly 169, and as the guide rod 135 rotates, and the threaded bracket 150 moves along the threaded guide rod 135, the bracket 150 and roller assembly 169 can traverse back and forth along the threaded rod 135 to help guide power cord 105 wind or unwind on the cylinder 110. In some embodiments, the roller assembly 169 can comprise a guide pulley comprising lower rollers 162, 164, and a tension pulley comprising upper roller 166.

As shown in at least FIGS, 11A and 11B, in some embodiments, the lower rollers 162, 164 can be supported by and travel on lower rod 122, and the upper roller 166 can be supported by tensioner rod 120 which is driven as part of the gear assembly 118 by coupled to gear 119 by gear 117 coupled to the tensioner rod 120 at the second end side 102a. As shown in FIGS. 11A and 11B, in some embodiments, the power cord 107 can travel between the lower rollers 162, 164.

In some embodiments, as the roller motor 115 drives the rotation of the cylinder 110, the gear 119 coupled to the cylinder 110 can rotate, which rotates gear 117, thereby rotating coupled tensioner rod 120. This in turn rotates the upper roller 166 which can be used to move the power cord 107 into or out of the internal storage compartment 103 of the housing 100, where the cord 107 can wind or unwind to or from the cylinder 110 (wound cord shown as power cord 105). In this instance, the coordinated movement of the cylinder 110, tensioner rod 120, bracket 150, and cord 107 between lower rollers 162, 164 can ensure the power cord 105 is compactly and efficiently wound on the cylinder 110, and/or is readily unwound from the cylinder 110.

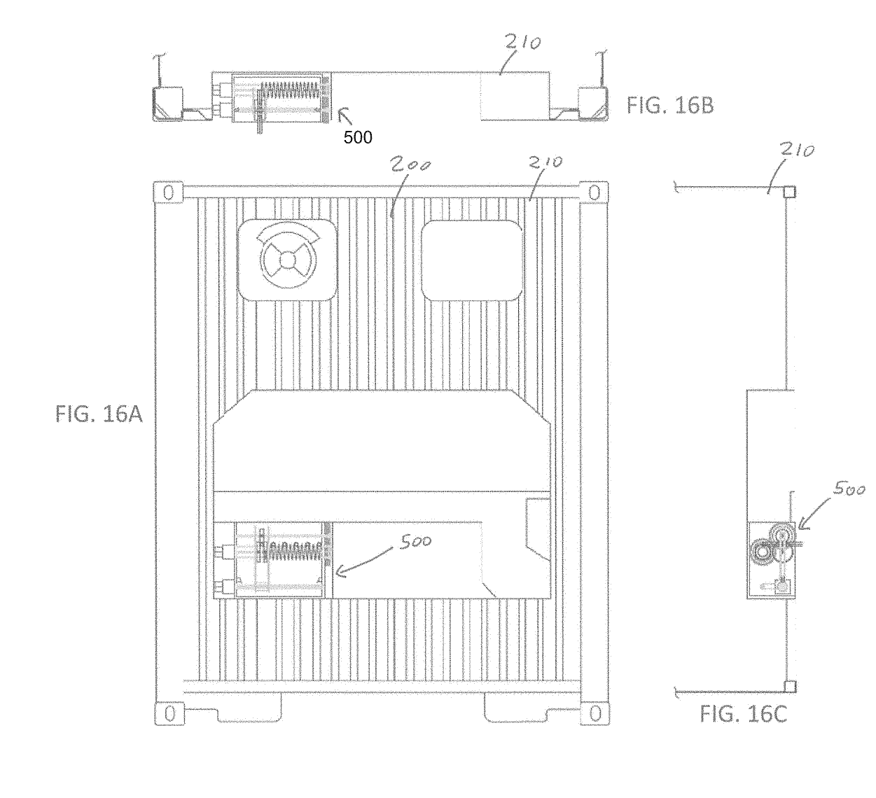

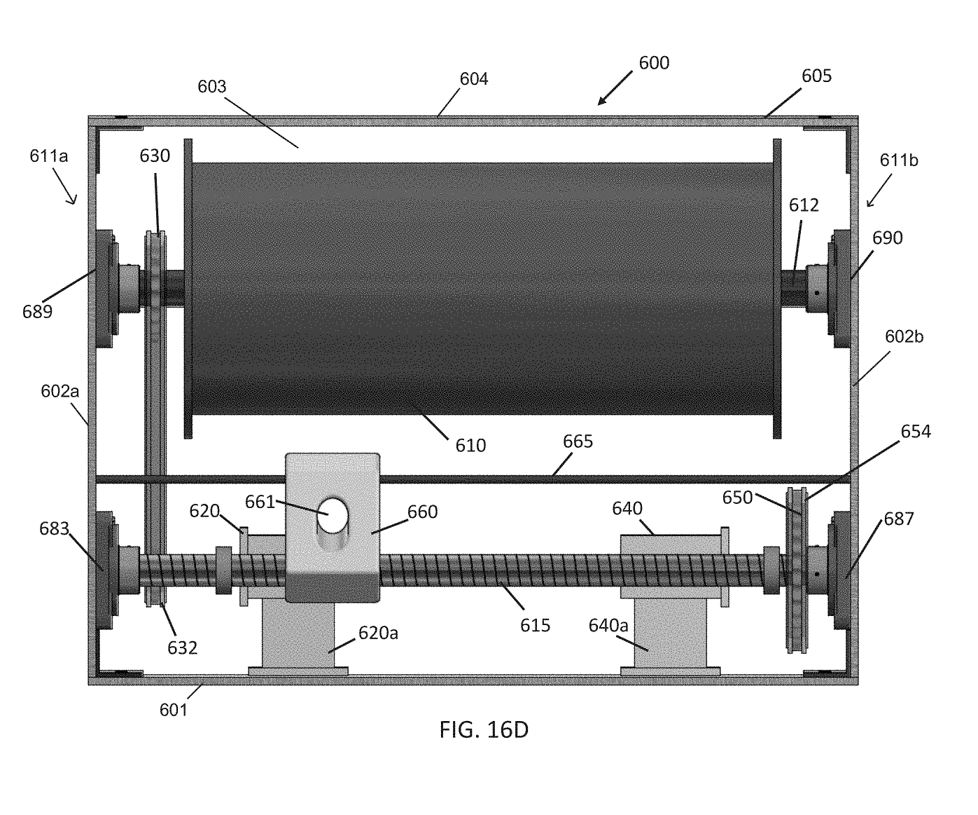

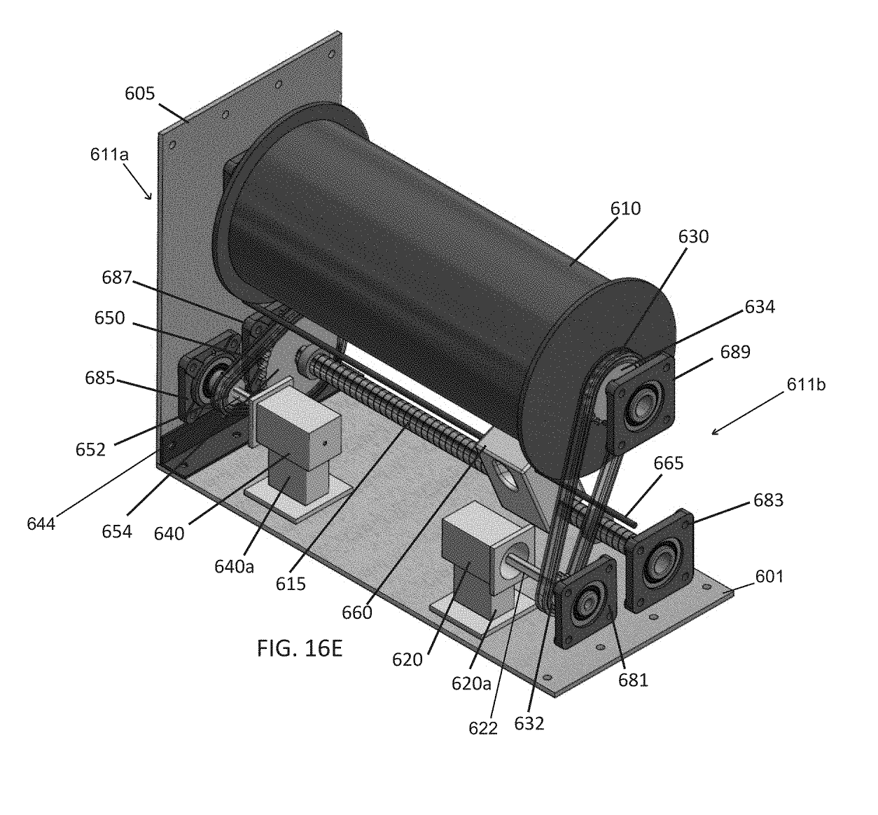

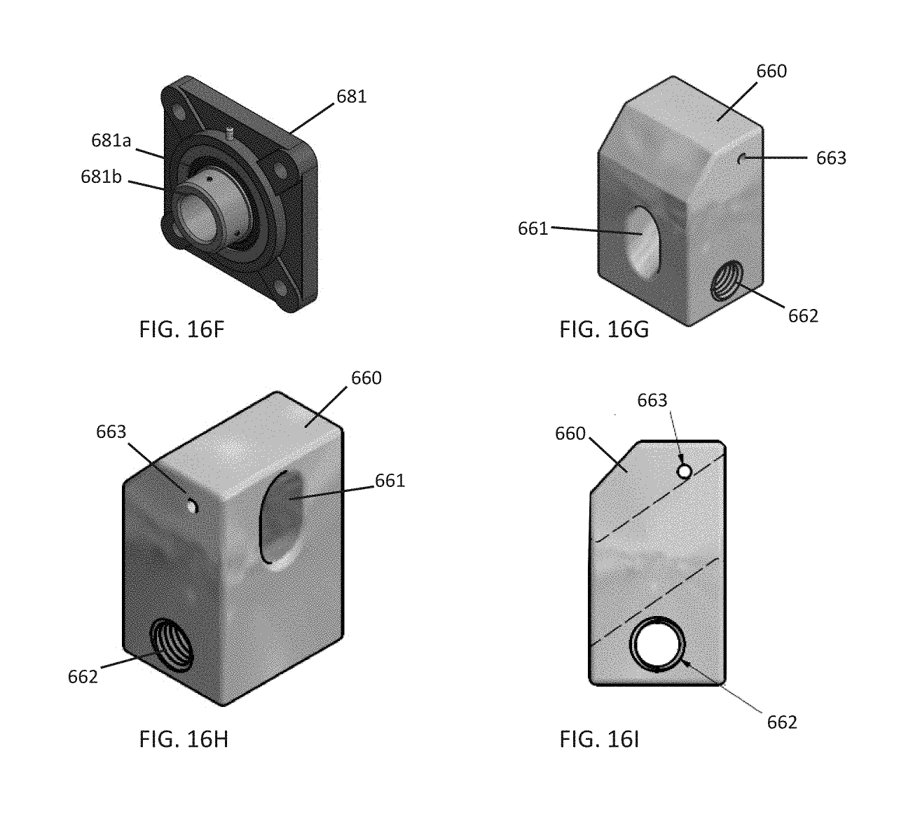

FIGS. 16A-16C show installed views of a reefer cord system 500 in accordance with some embodiments of the invention. For example, FIG. 16A shows an installed view of a reefer cord system 500 in a container 200 positioned coupled to at least a portion of the container housing 210, in accordance with some embodiments of the invention. Further, FIG. 16B shows a cutaway cross-section top view of the reefer cord system 500 in a container 200 in accordance with some embodiments of the invention, and FIG. 16C shows a cutaway cross-section side view of the reefer cord system 500 in a container 200 in accordance with some embodiments of the invention.

In some embodiments, the installed reefer cord system 500 can comprise the reefer cord system 10. In some embodiments of the invention, the reefer cord system 500 can include a specification to fit within a conventional cord containment area of about 16″×24″×10″. In some embodiments of the invention, the reefer cord system 500 can fit within a conventional cord containment area of less than or greater than about 16″×24″×10″.

In some embodiments, the reefer cord system 500 can include a 16″ cylinder that is mounted in the current containment area (e.g., based on a minimum wrapping diameter for ¾ inch cord). In some embodiments, the reefer cord system 500 can include ample room to store a plug, and for a cord guide to properly positioned to enable the plug to be stored beneath the cylinder. In some embodiments, the reefer cord system 500 can include a cord guide assembly to ensure that the power cord 107 rolls up neatly and does not rub the inside of the wall with at least 65 feet and up to 74 feet of ¾ electric cord. Further, some embodiments include a mounting bracket at each end where with a slight pull of the reefer cord, the cylinder can self-retract with the cord spooling up neatly using the sliding cord guide. In some embodiments of the invention, the reefer cord system 500 can include low RPM motors (e.g., such those available from W.W. Grainger, Inc. for about $1,300), and can comprise a length of about 16″. In some embodiments, the power output can be about one horsepower. Other embodiments can utilize smaller sized and lower power electric motors. Some further embodiments can include larger-sized motors and/or higher power motors.

Some embodiments include a cylinder (110) with a 4″ cylinder, and a cylinder length of 9.75″. In this instance, three full wraps/layers can hold 63.81′ of wire, and the outer flanges of the cylinder can be just under 10″. In some embodiments, the size of the cylinder can change based at least in part on the thickness and length requirements of the power cord 105, 107.

Some embodiments include a remote or local control of reel-in and reel-out of a power cord 105, 107. For example, some embodiments include a remote or local control of reel-in and reel-out from a remote or local mounted keyboard or other remote or locally mounted or coupled controller. In some embodiments, the user can actuate the reel-in or reel-out push-buttons on a local control panel to operate an integrated electrical motor (e.g., such as roller motor 115 and/or guide motor 137). In a non-limiting example embodiment, in some embodiments, roller motor 115 can then operate the cylinder 110 in the selected direction as specified by the user.

Some embodiments include a remote and/or wireless control of reel-in and/or reel-out of the power cord 105, 107. For example, some embodiments include RF components operation compatible with Bluetooth® communication protocols that enable a wireless control of reel-in and/or reel-out of the cord from a cylinder. In some embodiments, the reefer cord system 10 can accept a container number into a Bluetooth® control device, after which the user is given access to reel-in and/or reel-out operation of the cylinder (110). Bluetooth is a registered trademark owned by Bluetooth®SIG.

Some embodiments include a mechanical extension and/or retraction mechanism that is configured so that if an electrical operation fails, the user can reel-in and/or reel-out the power cord 105, 107 via the integrated retractable cord cylinder system. In some embodiments, this functionality can be achieved using a pull down retract (e.g., such a spring-loaded retract mechanism). In some embodiments, the mechanical extension and/or retraction can be accomplished with a hand-crank. In some embodiments, the mechanical system can be designed to automatically disengage itself from the electrical motor when actuated. In some embodiments, a spring motor can be used to provide even tensioning of the cord.

Some embodiments include a spring-loaded retractable cylinder 110 which will recoil the cord at a controlled pace (and therefore will not quickly snap back in an uncontrolled or rapid manner). In some embodiments, this unit is a bolt on unit that can be installed very quickly on existing reefers. In some embodiments, this unit will not include an electrical motor, and can be installed on existing reefers already in use. Some further embodiments include the previously described spring-load option in addition to an electrical motor which will couple to the electrical wiring of the reefer unit. In some embodiments, the spring-loaded retractable cylinder with electric motor can be wirelessly controlled as described earlier.

In some embodiments, one or more components and/or structures of the reefer cord system 10 can be color-coded to enable a type identification of by a user (e.g., such as identifying if the user is a mechanic or longshoreman). In some embodiments, one or more components and/or structures of the reefer cord system 10 can be labeled or can include at least one physical structure to aid identification by the user.

In some embodiments of the invention, the power cord 105, 107 can comprise an electrical cable capable of carrying and providing a power supply at 460 volts. In some embodiments, various conventional power cord 105, 107 and plug designs can be used for the 460 volt power supply. In some embodiments, one or more plug options of the power cord 105, 107 can be tailored to each customer's requirements. Further, in some embodiments, one or more plug options of the power cord 105, 107 can be interchangeable with one or more alternative plug components or options.

Some further embodiments of the invention include assemblies with roller and guide motors positioned inside the of the housing and/or assemblies with a guide for the power cord. For example, FIG. 16D shows a front view of a reefer cord system 600 in accordance with some further embodiments of the invention, and FIG. 16E shows a perspective view of a reefer cord system 600 of FIG. 16D, shown without the end side 602b. Some embodiments include a reefer cord system 600 that comprises a frame or housing 605 that functions as a housing and support structure for one or more motors, gears, shafts, rods of the reefer cord system 600. In some other embodiments, the frame or housing can comprise base 601. In some embodiments, the reefer cord system 600 can be adjusted for any size and shape. In some embodiments, the reefer cord system 600 can be sized for use with a standard shipping container, or can be applied to any other container sizes. In some embodiments, the housing 605 can include two end sides 602a, 602b, with end side 602a positioned at a first end 611a, and an end side 602b positioned at a second end 611b. In some embodiments, the reefer cord system 600 can comprise base 601 extending at least a partial length of the two end sides 602a, 602b. Further, in some embodiments, the housing 605 can comprise a top side 604 extending from the first end 611a to the second end 611b by extending from the end side 602a and end side 602b. In some embodiments, the coupled arrangement of the two end sides 602a, 602b, base 601 and/or top side 604 can form an internal storage compartment 603 of the housing 605. Although not shown in the figures, the housing 605 can include a rear and/or front side extending between the first end 611a and second end 611b, and along at least a partial length of the two end sides 602a, 602b. However, any front or rear side can be sized to not cover or interfere with a cord passing into the internal storage compartment 603.

In some embodiments, the reefer cord system 600 can include a roller motor 620 positioned adjacent the second end 611b. In some further embodiments, the reefer cord system 600 can include a guide motor 640 positioned adjacent the first end 611a. In some embodiments, the roller motor 620 can be coupled to the base 601 by a motor mount 620a. In some embodiments, the guide motor 640 can be coupled to the base 601 by a motor mount 640a.

In some embodiments of the invention, the reefer cord system 600 can include a rotatable cylinder 610 that can be used as storage support for a power cord. For example, in some embodiments, the cylinder 610 can be used to retract or extend, store or provide an electrical reefer cord (e.g., a power cord). In some embodiments of the invention, the roller motor 620 can be used to rotate the cylinder 610 via a belt or chain 630. In some embodiments, the belt or chain 630 can couple to a drive shaft 622 of the roller motor 620 via a cog 632 coupled to the drive shaft 622, and can couple to cog 634 of cylinder shaft 612. In some embodiments, as the roller motor 620 rotates the drive shaft 622, the cog 632 can rotate, and the belt or chain 630 can rotate cog 634 and cylinder shaft 612, thereby rotating the cylinder 610.

In some embodiments of the invention, the reefer cord system 600 can include a moveable guide 660 that can be used to guide a power cord to and from the internal storage compartment 603, and onto or off the cylinder 610. In some embodiments of the invention, a guide motor 640 can be used to rotate a guide rod or shaft 615 via a belt or chain 650. In some embodiments, the belt or chain 650 can connect to a drive shaft 644 of the guide motor 640 via a cog 652 connected to the drive shaft 644, and can be coupled to cog 654 of guide shaft 615. In some embodiments, as the guide motor 640 rotates the drive shaft 644, the cog 652 can rotate, and the belt or chain 650 can rotate cog 654 and guide shaft 615. In some embodiments, the roller motor 620 can drive the cylinder 610 to retract or extend a power cord, depending on whether the roller motor 620 operates in one drive direction versus an opposite drive direction. In some embodiments, as the guide shaft 615 rotates, a threaded guide 660 can move along the threaded guide shaft 615, where the guide 660 can traverse back and forth along the guide shaft 615 to help guide a power cord during a wind or unwind to or from cylinder 610.

In some embodiments, rotation and/or support of the various shafts and/or rods of the reefer cord system 600 in a housing (such as housing 605) can be accomplished by various bearing flanges. For example, FIG. 16F shows an example bearing flange 681 in accordance with some embodiments of the invention, showing the bearing flange 681 shown earlier in FIG. 16E that rotatably supports the drive shaft 622 of the roller motor 620. In some embodiments, the bearing flange 681 can comprise a shaft support 681b that can be rotatably supported by bearings 681a. In some embodiments, other bearing flanges of the reefer cord system 600 can comprise bearing flange 681, and may be the same size, smaller, or larger that bearing flange 681. For example, other bearing flanges can comprise bearing flange 685 (rotatably supporting drive shaft 644), and/or bearing flange 687 (rotatably supporting guide shaft 615 at the first end 611a), and/or bearing flange 683 (rotatably supporting guide shaft 615 at the second end 611b), and/or bearing flange 689 (rotatably supporting cylinder shaft 612 at the second end 611b), and/or bearing flange 690 (rotatably supporting cylinder shaft 612 at the first end 611a), anyone of which be structured as bearing flange 681 to provide a rotational support of a coupled rotating shaft or rod.

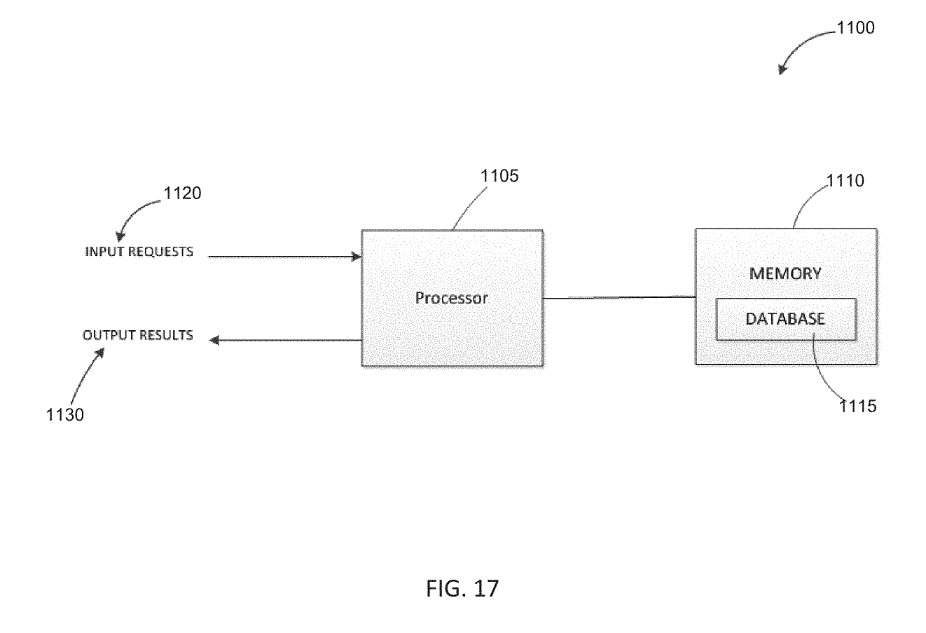

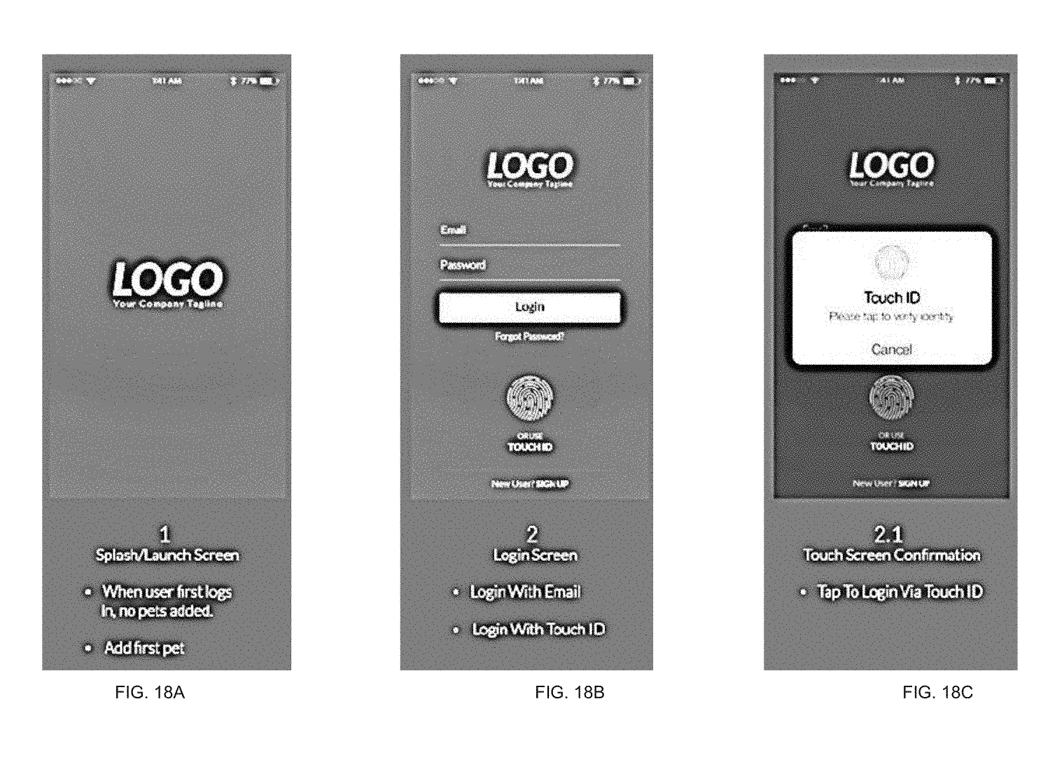

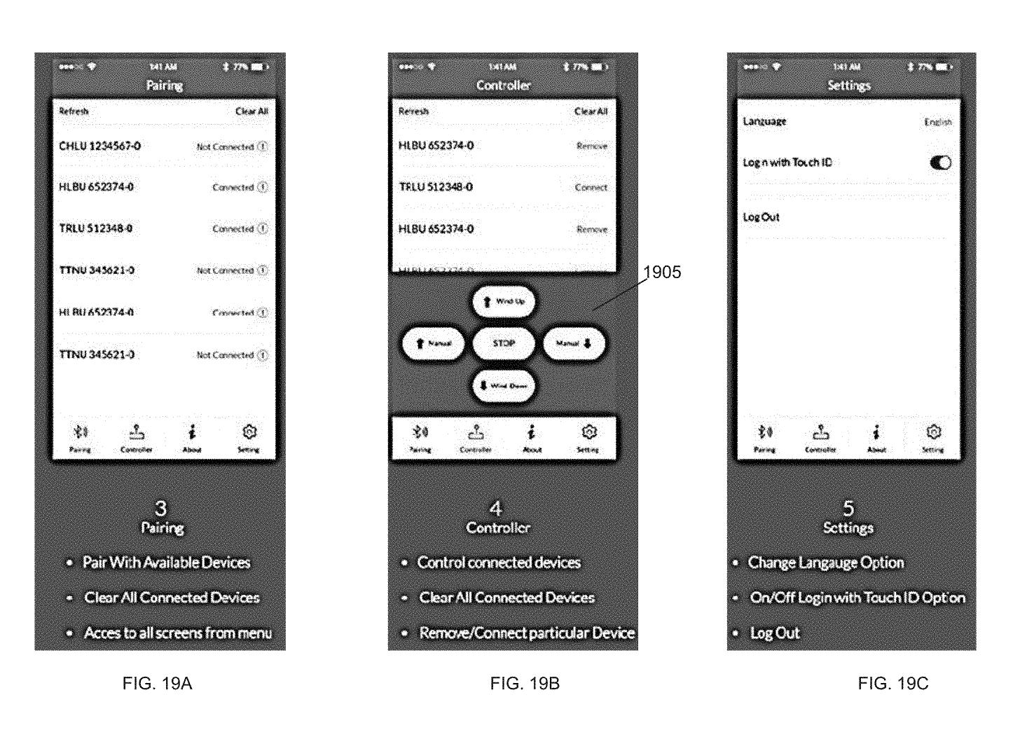

In some embodiments, a power cord can be supported through the cord aperture 661 of the guide 660 which can be moveable supported by a support rod 665 extending from the end side 602a to the end side 602b, where the support rod passes through aperture 663. For example, in some embodiments, a power cord the same or similar to the power cord 107 can be fed into and out of the reefer cord system 600. FIGS. 16G-161 show the guide 660 in more detail. For example, FIG. 16G shows a front perspective view of a guide 660 in accordance with some embodiments of the invention, FIG. 16H shows a rear perspective view of a guide 660 in accordance with some embodiments of the invention, and FIG. 16I shows a side view of a guide 660 in accordance with some embodiments of the invention.

In some embodiments of the invention, any of the retractable reefer cord assemblies and/or systems described herein, including reefer cord systems 10, 600 can comprise a remote monitoring capability or function. In some embodiments, the remote monitoring capability or function can include monitoring and/or controls for various parameters, including, but not limited to, temperature, cooling, defrosting, and a within range status. In some embodiments, the reefer cord systems 10, 600 can comprise a remote monitoring receptacle that enables connection of remote indicators for cool, defrost and in range parameters or limits. In some embodiments, the receptacle can be mounted at the location of a control box of the reefer cord system. In some embodiments, the control box can include various control functions, including, but not limited to, manual operation switches, a circuit breaker, a compressor, a fan and heater contactors, a control power transformer, fuses, a key pad, a display module, a current sensor module, a controller module, and the communications interface module.

In some embodiments, any of the retractable reefer cord assemblies and/or systems described herein, including reefer cord systems 10, 600, can comprise a communications interface module. In some embodiments, the reefer cord system may be fitted with a communications interface module. In some embodiments, the communications interface module can be a slave module that can allow communication with a master central monitoring station. In some embodiments, the module can respond to communication and return information over the main power line. In some embodiments, the module can respond to communication and return information over the ship master system.

In some embodiments, any of the retractable reefer cord assemblies and/or systems described, including reefer cord systems 10, 600, can be controlled by a controller using controller software. In some embodiments, the controller software can be a custom designed program that is subdivided into configuration software and operational software for performing one or more methods or processes. Accordingly, in some embodiments, the reefer cord system can comprise a power cord system and method. In some embodiments, the power cord system and method can include a system including logic for processing at least a portion of the controller software and/or can be coupled to a system including logic configured to process at least a portion of the controller software. Turning to FIG. 17, a block diagram of a system 1100 implementing at least some portion of a controller software is shown. In some embodiments, the system 1100 can include a processor 1105 coupled with a memory 1110, where the memory 1110 is configured to store data. In some embodiments, the processor 1105 can be configured to interface or otherwise communicate with the memory 1110, for example, via electrical signals propagated along a conductive trace or wire. In an alternative embodiment, the processor 1105 can interface with the memory 1110 via a wireless connection. In some embodiments, the memory 1110 can include a database 1115, a plurality of data or entries stored in the database 1115 of the memory 1110. In some embodiments, the processor 1105 can be tasked with executing software or other logical instructions in order access, monitor, and/or control the reefer cord system. In some embodiments, input requests 1120 can be received by the processor 1105 (e.g., via signals transmitted from a user at a remote system or device, such as a handheld device like a smartphone or tablet, to the processor 1105 via a network or internet connection). In an alternative embodiment, the input requests 1120 can be received by the processor 1105 via a user input device that is not at a geographically remote location (e.g., via a connected keyboard, mouse, etc. at a local computer terminal). In some embodiments, after performing tasks or instructions based upon the user input requests 1120, for example, looking up information or data stored in the memory 1110, the processor 1105 can output results 1130 back to the user that are based upon the input requests 1120.

In some embodiments, at least a portion of the system 1100 can be included in housing of the reefer cord system 10 shown in at least FIGS. 10A-10B and/or FIGS. 11-12, or the reefer cord system 600 of FIGS. 16D-16E. In some further embodiments, at least a portion of the system 1100 can be included with or coupled to an external controller. In some embodiments, the system 1100 can include or be coupled to a remote and/or wireless control of reel-in and/or reel-out of a cord of the reefer cord system. For example, in some embodiments, the system 1100 can include, or can be coupled to RF components compatible with Bluetooth® communication protocols that enable a wireless control of the reefer cord system as described earlier.

In some embodiments, some portion of a controller software of the system 1100 can control supply or return air temperature to specific limits, and/or provide modulated refrigeration operation, and/or enable economized operation, and/or an unloaded operation, and/or electric heat control and defrost. In some embodiments, the defrost can be performed to clear buildup of frost and ice and ensure proper air flow across the coil.

In some embodiments of the invention, some portion of the controller software can provide default independent readouts of set point and supply or return air temperatures. In some further embodiments, some portion of the controller software can provide the ability to read and (if applicable) modify the configuration software variables, operating software function codes and alarm code indications. In some other embodiments, some portion of the controller software can provide a pre-trip step-by-step checkout of refrigeration unit performance including, but not limited to: proper component operation, and/or electronic and refrigeration control operation, and/or heater operation, and/or probe calibration, and/or pressure limiting and current limiting settings. In some embodiments, some portion of the controller software can provide battery-powered ability to access or change selected codes and set point without AC power connected. In some other embodiments, some portion of the controller software can provide the ability to re-program the software through the use of a memory card.

In some embodiments, reefer cord systems 10, 600 can comprise open-source hardware and/or software. In some non-limiting example embodiments, the reefer cord systems 10, 600 can comprise an Arduino® controller, and/or an Adafruit® Wi-Fi Board, and/or an Arduino® 2 channel relay board, where any one of which can couple to a Wi-Fi equipped cellphone or smartphone and one or more applications of the cellphone or smart phone. In some embodiments, the assemblies or systems coupled to each container can consist of a 24 Vdc reversing motor controlled by an Arduino® Nano controller through a set of forward and reverse relay contacts. Other embodiments can utilize any conventional Wi-Fi system and/or controller.

In some embodiments, a cellphone or smart phone application can be used to communicate via Wi-Fi. For example, some embodiments can include the system 1100 comprising or coupled to a cellphone or smart phone application. In some embodiments of the invention, each controller can be programmed with a unique container number of the container to which it is installed. In some embodiments, the user can select a container number from a pull-down list, or by manually typing the container number into the cellphone or smart phone application. In some embodiments, once the number has been entered, the user can be provided with a direct link to the controller on the selected container. Arduino® is a trademark of Arduino LLC. Adafruit is a trademark of Fried, Limor. Adafruit Industries, Inc., 150 Varick Street, New York, N.Y. 10013 (http://www.adafruit.com).

In some embodiments of the invention, the reefer cord systems 10, 600 can include one or more controls on a cellphone or smart phone application that can enable the user to raise or lower a power connector of the reefer cord system. In this instance, the user can press “Up” or “Down” buttons on the one or more controls. In some embodiments, when a down signal is received, the controller can turn on the reverse relay, and apply 24 Vdc to the motor. In some embodiments, the motor can rotate in a direction which will lower the cable and plug assembly from the container. In some further embodiments, if the user presses the “Up” button, the forward relay can be energized by the controller, causing the 24 Vdc motor to rotate in the direction which will raise the cable. In some embodiments, the user can de-select the container when the cable movement has been completed. In some embodiments, the user can then select the next container from a drop-down list, or type in the next container number. In some embodiments of the invention, power for any of the motors described earlier can and the controller can be supplied by a 24 Vdc battery. In some embodiments, this battery can be charged whenever the refrigeration unit is on power.

In some embodiments of the invention, the one or more applications of a user's mobile communication or computing device (e.g., such as a cellphone or smart phone) can comprise an application programming interface (API). As illustrated in FIGS. 18A-18C and 19A-19C, in some embodiments, the API of the reefer cord systems 10, 600 can display information in a mobile interface that can be used to control one or more functions of the reefer cord system. In reference to FIGS. 18A-18C, some embodiments include a launch display and login display to enable a user to log into the reefer cord systems 10, 600. As shown, some embodiments include a “touch ID” entry for security (FIG. 18C). Other embodiments include any conventional login security protocol such as username and password, two-factor authentication, etc., (FIG. 18B).

Some embodiments include pairing, controlling, and/or setting display screens. For example, in some embodiments, the pairing display of FIG. 19A can be used to pair the user's device with one or more components of the reefer cord systems 10, 600. In some embodiments, the controller display of FIG. 19B can be used to wind-up or wind-down the reefer cord of the system. For example, in some embodiments, automated or semi-automated wind-up or wind-down can be accomplished with the wind-up or wind-down buttons 1905. In some embodiments, these manual buttons can be used to incrementally wind-up or wind-down the reefer cord. Further, in some embodiments, the controller display can be used to clear connected devices and/or to connect or remove devices from the API. In some embodiments, settings and/or log-off options can be provided with the non-limiting embodiment of a display FIG. 19C.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A cord support system for a container, comprising:
a housing configured and arranged for coupling to a container;
a cylinder supported for rotation;
a guide moveably coupled to a guide shaft;
a roller motor coupled to rotate the rotatable cylinder; and
a guide motor coupled to rotate the guide shaft.

2. The cord support system of claim 1, further comprising a belt or chain coupled to a drive shaft of the roller motor and a shaft of the cylinder.

3. The cord support system of claim 1, wherein the guide comprises a block including at least one aperture.

4. The cord support system of claim 3, wherein the at least one aperture comprises a threaded aperture.

5. The cord support system of claim 3, wherein the guide is coupled to a support rod.

6. The cord system of claim 5, wherein the guide shaft is positioned through the at least one aperture, wherein upon a rotation of the guide shaft by the guide motor, the guide is configured to move along the guide shaft.

7. The cord system of claim 1, wherein the guide shaft is positioned through the guide, wherein upon a rotation of the guide shaft by the guide motor, the guide is configured to move along the guide shaft.

8. The cord system of claim 7, wherein the guide comprises an aperture configured to support a power cord, wherein upon a rotation of the guide shaft by the guide motor, the guide is configured to move along the guide shaft moving a position of a portion of the power cord along a length of the rotatable cylinder.

9. A system comprising;
a rotatable cylinder;
a guide moveably coupled to a rotatable guide shaft;
a roller motor configured to rotate the rotatable cylinder; and
a guide motor configured to rotate the guide shaft;
at least one processor; and
a non-transitory computer-readable storage medium for tangibly storing thereon program logic for execution by the processor, the program logic comprising:
logic executed by the processor for controlling at least one of the roller motor and the guide motor.

10. The system of claim 9, further comprising logic executed by the processor for displaying a user interface of a controller, the user interface configured to include a display of one or more controls for controlling rotation of at least one of the rotatable cylinder and the guide shaft.

11. The system of claim 10, wherein the user interface comprises a remote wireless user device.

12. The system of claim 9, further comprising logic executed by the processor for storing in the non-transitory computer readable medium a specific container number of a container coupled to the system.

13. The system of claim 12, further comprising logic executed by the processor to establish a direct link to the controller of the system for the specific container number.

14. The system of claim 10, wherein the controls comprise at least one of “up” and “down” buttons to control rotation of at least one of the rotatable cylinder to wind-up or wind-down a power cord.

15. The system of claim 10, further comprising logic executed by the processor to display at least one of a launch display and login display to enable a user to log into the system, and a “touch ID” entry for security, and a login security protocol including at least one of a username and password, and two-factor authentication.

16. A system comprising;
a rotatable cylinder;
a roller motor configured to rotate the rotatable cylinder; and
a moveable assembly configured to feed a power cord to or from the rotatable cylinder;
at least one processor; and
a non-transitory computer-readable storage medium for tangibly storing thereon program logic for execution by the processor, the program logic comprising:
logic executed by the processor controlling at least one of the roller motor, rotation of the cylinder, and the feed of the power cord.

17. The system of claim 16, further comprising logic executed by the processor enabling a container number to be entered from a remote user interface and establishing a direct link to a controller of the system coupled to a container associated with the container number.

18. A cord system for a container comprising;
a rotatable cylinder;
a roller motor configured to reversibly rotate the cylinder; and
a moveable assembly configured to guide a power cord to or from the rotatable cylinder;
at least one processor; and
a non-transitory computer-readable storage medium for tangibly storing thereon program logic for execution by the processor, the program logic comprising:
logic executed by the processor for controlling at least the roller motor; and
logic executed by the processor enabling a container number to be entered from a remote user interface establishing a link to the cord system coupled to the container.
